(19) United States
(12) Patent Application Publication
(10) Pub. No.: US 2008/0165805 A1
(43) Pub. Date: Jul. 10, 2008

(54) NODE B BASED SEGMENTATION/CONCATENATION

(75) Inventors: Stephen E. Terry, Northport, NY (US); Sudheer A. Grandhi, Mamaroneck, NY (US); Diana Pani, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/969,691

(22) Filed: Jan. 4, 2008

Related U.S. Application Data
(60) Provisional application No. 60/883,475, filed on Jan. 4, 2007.

(51) Int. Cl. H04B 7/216; H04J 13/00

(52) U.S. Cl. 370/474; 370/335; 370/342

(57) ABSTRACT

The disclosed method and processor include data-flow multiplexing, segmentation and concatenation at the Node B MAC Layer. Such a method and apparatus support higher throughput due to the reduction in latency.

### CROSS REFERENCE TO RELATED APPLICATION(S)

This application claims the benefit of U.S. provisional application No. 60/883,475, filed on Jan. 4, 2007, which is incorporated by reference as if fully set forth.

### FIELD OF INVENTION

The present invention generally relates to wireless communication systems.

### BACKGROUND

High Speed Packet Access Evolution (HSPA+) refers to 3GPP radio-access technology evolution of HSDPA and Enhanced Uplink (HSUPA). Some of the major goals of HSPA include higher data rates, higher system capacity and coverage, enhanced support for packet services, reduced latency, reduced operator costs and backward compatibility. In order to meet these goals, evolutions to the radio interface protocol and network architecture are required.

The main functions of the Medium Access Control (MAC) and Radio Link Control (RLC) protocols have as impact on performance with respect to their location in the HSPA+ architecture. In accordance with the evolutions to the radio interface protocol, the main functions of the Medium Access Control (MAC) protocol may include: (1) Channel mapping; (2) Multiplexing; (3) Quality of Service (QoS), for example priority, scheduling, and rate control; (4) Link Adaptation (i.e., QoS, Multiplexing); and (5) Hybrid Automatic Repeat Request (HARQ).

MAC Protocol Data Units (PDUs) that are sent to the physical layer are called Transport Blocks (TBs). A set of TBs are sent every Transmission Time Interval (TTI) to the physical layer with a corresponding Transport Format (TF), which describes the physical layer attributes. If the TB set is derived from combining or multiplexing more than one logical RLC channel then a combination of TFs known as Transport Format Combination (TFC) is used.

As part of Link Adaptation the MAC performs the TFC selection based on RLC logical channel priority, RLC buffer occupancy, physical channel conditions, and logical channel multiplexing. MAC TFC selection may include for example the Transport Format Resource Combination (TFRC) selection in the MAC-hs of HSDPA.

The RLC protocol has an impact on the latency and throughput of data in Layer 2. In Release 6 systems, the RLC protocol is located in the Radio Network Controller (RNC) node. The main functions of the Tx RLC protocol include: (1) Macro-diversity; (2) Segmentation; (3) Concatenation; (4) Error Detection and Recovery; and (5) HARQ Assisted ARQ. The main functions of the RX Upper RLC protocol include: (1) Duplicate detection; (2) in sequence delivery; (3) full macro-diversity (Inter-Node B, Intra-Node B); (4) Error Detection and Recovery; (5) HARQ Assisted ARQ; (6) Reassembly; and (7) Intra-Node B macro-diversity.

In the Acknowledged mode (AM) operation (e.g., some U-plane data) the RLC protocol is bi-directional, with status and control information sent from Rx RLC to Tx RLC. In the Transparent and Unacknowledged mode (UM) operation (e.g. some C-plane RRC signaling) the RLC protocol is unidirectional where the Tx RLC and Rx RLC are independent with no status and control information exchange. Also some of the functions such as HARQ Assisted ARQ and Error Detection and Recovery are used only in AM operation.

The RLC PDU sizes are determined by the RRC based on the long term QoS requirements of the applications carried by the logical channels. The RLC is configured on a semi-static basis by the RRC with these pre-determined RLC PDU sizes.

It should be appreciated by those having skill in the art that a Node B is the Universal Mobile Telecommunications System (UMTS) function that provides a physical radio link between a wireless transmit receive unit (WTRU) and the network. The Node B also applies the codes necessary to describe channels in a code division multiple access (CDMA) system, along with the transmission and reception of data across the radio interface.

As indicated above, the primary goals of the HSPA evolution are decreased latency and increased throughput for packet services. Currently, the architectures for HSPA retain the Node B and RNC elements in the UTRAN. However the mapping of the MAC and RLC protocol functions to the network elements in the UTRAN may be different and the protocols themselves may be modified. The protocol changes may be implemented in conjunction with changes in mapping of protocol functions to the network elements. As such, delays may be introduced which can result in increased latency and decreased throughput.

Accordingly, there exists a need for a method and apparatus for overcoming these concerns.

### SUMMARY

The disclosed method and processor include data-flow multiplexing, segmentation and concatenation at a Node B MAC Layer. Such a method and apparatus support higher throughput due to the reduction in latency.

### BRIEF DESCRIPTION OF THE DRAWINGS

A more detailed understanding may be had from the following description of a preferred embodiment, given by way of example and to be understood in conjunction with the accompanying drawings wherein:

FIG. 1 shows a block diagram of a receiver and transmitter configured to implement the disclosed method and apparatus;

FIG. 2 shows a block diagram of a transmitter at a Node B in accordance with the disclosed method;

FIG. 3 shows a block diagram of a receiver at a wireless transmit receive unit (WTRU) in accordance with the disclosed method;

FIG. 4 shows a flow diagram of the disclosed method implemented by the transmitter illustrated in FIG. 2;

FIG. 5 shows a flow diagram of the disclosed method implemented by the receiver illustrated in FIG. 3;

FIG. 6 shows a block diagram of a transmitter at a Node B with ARQ instance at the UTRAN side;

FIG. 7 shows a block diagram of a receiver configured to implement the method used by the transmitter shown in FIG. 6;

FIG. 8 shows a flow diagram of the disclosed alternative method implemented by the transmitter illustrated in FIG. 6;

FIG. 9 shows a block diagram of an alternative transmitter configured to implement the disclosed alternative method including a single ARQ after multiplexing; and

FIG. 10 shows a flow diagram of the alternative method implemented by the receiver shown in FIG. 7.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

Abbreviations

ARQ—Automatic Repeat Request

CN—Core Network

CP—Control Plane

CS—Circuit Switched

DL—Down Link

HARQ—Hybrid Automatic Repeat Request

HSDPA—High Speed Downlink Packet Access

HSUPA—High Speed Uplink Packet Access

IP—Internet Protocol

LCID—Logical Channel Identifier

LTE—Long Term Evolution

MAC—Medium Access Control

PDCP—Packet Data Convergence Protocol

PS—Packet Switched

PDU—Protocol Data Unit

RAN—Radio Access Network

RLC—Radio Link Control

RoHC—Robust Header Compression

RRC—Radio Resource Control

RRM—Radio Resource Management

SAP—Service Access Point

SDU—Service Data Unit

UE—User Equipment

UL—Up Link

UP—User Plane

UMTS—Universal Mobile Telecommunications System

UTRAN—UMTS Terrestrial Radio Access Network

A disclosed method and apparatus introduce functionality with data-flow multiplexing, segmentation and concatenation, at a Node B for use with the MAC Layer. Such functionality supports a higher throughput due to the reduced latency provided by this functionality at the Node B.

It should be noted that throughout the description of the disclosed method, a higher layer data-flow could be a logical channel or a group of logical channels of common priority, Quality of Service (QoS), or transmission mode requirements (ie. AM, UM, TM). The Node B functionality can be part of the MAC sub-layer or it can be placed as a separate entity above the MAC sub-layer. It should be noted that the disclosed method is also applicable to downlink (DL), where the Node B functionality would be replaced by the WTRU functionality, to be disclosed below.

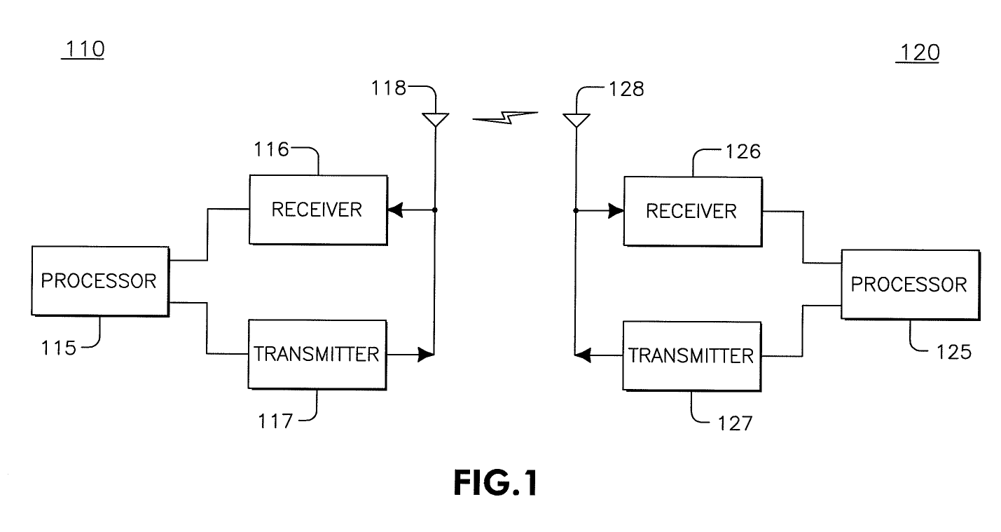

FIG. 1 is a functional block diagram of a transmitter and receiver 120, 110 configured to perform the disclosed method. In addition to components included in a typical transmitter/receiver, i.e., a WTRU or Node-B, transmitter and receiver 120, 110 include processors 125, 115 configured to perform the disclosed method of segmentation/concatenation, receivers 126, 116 in communication with processors 125, 115 transmitters 127, 117 in communication with processors 125, 115 and antenna 128, 118 in communication with receivers 126, 116 and transmitters 127, 117 to facilitate the transmission and reception of wireless data. Additionally, the receiver 126, transmitter 127 and antenna 128 may be a single receiver, transmitter and antenna, or may include a plurality of individual receivers, transmitters and antennas, respectively. Receiver 110 may be located at a WTRU or multiple transmitting circuits 110 may be located at a base station. Transmitter 120 may be located at either the WTRU, Node B, or both. For discussions purposes, it is assumed that wireless data is transmitted and received using HSPA+ system.

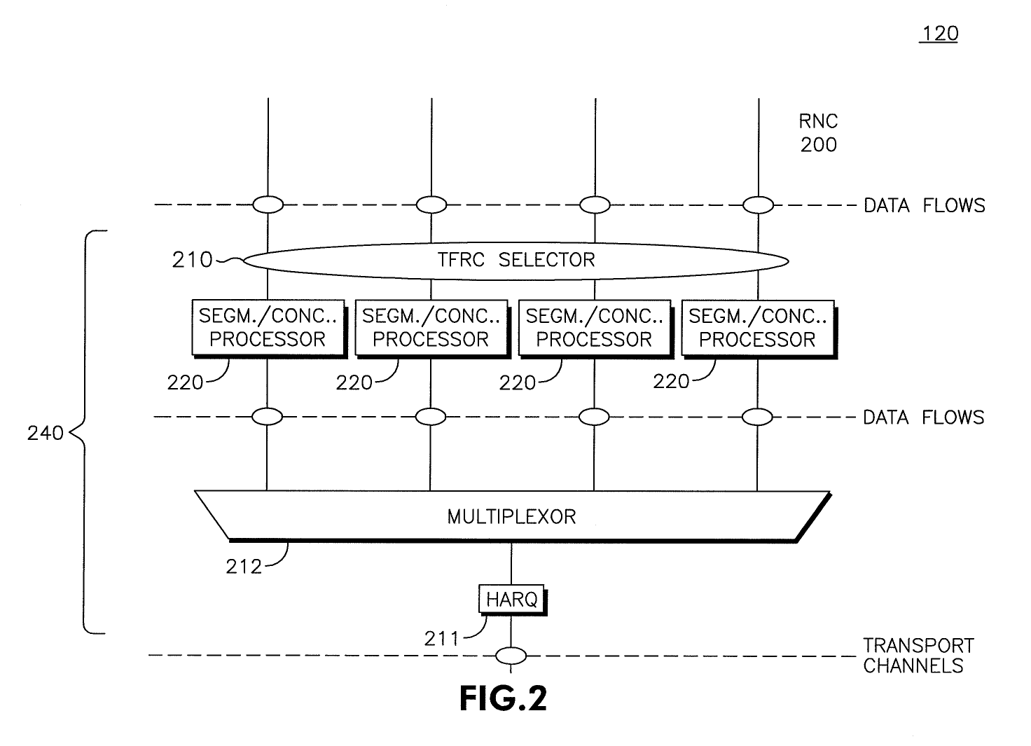

FIG. 2 is a block diagram of a disclosed transmitter 120 configured to implement the disclosed method of segmentation/concatenation with multiplexing of data flows. Disclosed transmitter 120, located at a Node B or a WTRU, comprises a MAC processor 240. Referring back to FIG. 2, preferably included in processor 125, shown in FIG. 1, MAC processor 240 comprises a Hybrid Automatic Repeat Request (HARQ) entity 211, a multiplexor 212, one or more segmentation/concatenation (segm./conc.) processor(s) 220, and a transport format resource combination (TFRC) selector 210. Receiver 120 receives a plurality of data packets from a WTRU through receiver 126, shown in FIG. 1, and forwards the data packet to Radio Network Controller (RNC) 200. RNC or higher layers 200 forwards to MAC processor 240 of the MAC sub-layer the received data packets.

TFRC selector 210 selects the TFRC based on channel conditions, such as, Channel Quality Indicator (CQI) reports from a WTRU, transmit power control information, physical resources available, and scheduling restrictions, for example. Based on these channel conditions, acceptable transport block (TB) sizes are selected. The selected TB information is forwarded to segm./conc. processors 220.

Segm./conc. processor 220, coupled to TFRC selector 210 and multiplexor 212, receives the data arriving from RNC or higher layers 200 and assembles the data using the selected TB information from TFRC selector 210. It is preferable that each data flow arriving from RNC or higher layers 200 be processed by a respective segm./conc. processor 220. Segm./conc. processor 220 segments or concatenates the received packets based on the TB size selected by TFRC selector 210 and data-flow priorities. If the packet received does not fit into a selected TB then the packet is segmented into a variable size Protocol Data Unit (PDU) without padding. If the packets are much smaller than the selected TB, the packets are concatenated. It should be noted that segments and full Service Data Units (SDUs) can be concatenated together. Segm./conc. processor 220 may perform the following: 1) Segment an SDU only when the SDU alone is too big to fit into the selected TB; or 2) Segment an SDU due to a concatenation result (e.g., if the SDU cannot be concatenated to a chain of other segments and SDUs without being segmented).

In accordance with the disclosed method, segm./conc. processors 220 preferably comprise a one to one correspondence with the data flows. Alternatively, if the higher layer data flows correspond to a group of logical channels, a function that separates them into their respective logical channels, priority queues, or transmission requirements may be introduced prior to segmentation/concatenation functionality. The data flows may correspond directly to the data flow received from the RNC or to a separated data flow, as described above.

As stated, segmentation and concatenation of higher layer data-flow PDUs is based on the TB size. For transmission management, retransmission, and re-assembly purposes, to be disclosed hereinafter, segm./conc. processors 220 preferably assign sequencing numbers to the packets created. The sequencing numbers may be based on one of the following: 1) PDU sequence numbering (per data flow), wherein a unique sequence number is generated for each PDU being created in the process; or 2) SDU sequence numbering, wherein segmentation information must be included with the generation of each sub-sequence number derived for each PDU. Alternatively, the SDU sequence number may be carried with the SDU sequence number and location information within the SDU (offset and length of segment from the beginning of the SDU).

If the amount of data available in the buffer is lower than the TFRC selection the transport block size will be restricted by the amount of data available. Alternatively, segm./conc. processor 220 can re-segment packets if HARQ 211 retransmissions fail and the packet size is larger than the TB to be retransmitted. Re-segmentation can be performed on a SDU level or PDU level.

The segmented and/or concatenated data flows are then forwarded to multiplexor 212. Multiplexor 212, coupled to segm./conc. processors 220 and HARQ entity 211, multiplexes the different data flows arriving from segm./conc. processors 220. In accordance with the disclosed method, combinations of one or a number of higher layer data-flows can be multiplexed into one or more TBs based on QoS requirements and available data. Some factors taken into account are: Modulation and Coding Schemes (MCS), Transmission Power, Multiple Input Multiple Output (MIMO) parameters.

Each multiplexed data flow is identified by a data flow ID. Preferably, the MAC header indicates the data-flow ID of each multiplexed packet. Alternatively, the multiplexing of different data flows can be performed prior to or after the segmentation/concatenation function.

HARQ entity 211, coupled to multiplexor 212, receives the multiplexed packet from multiplexor 212, manages the transmission and re-transmission of the multiplexed packets to a WTRU over the air interface.

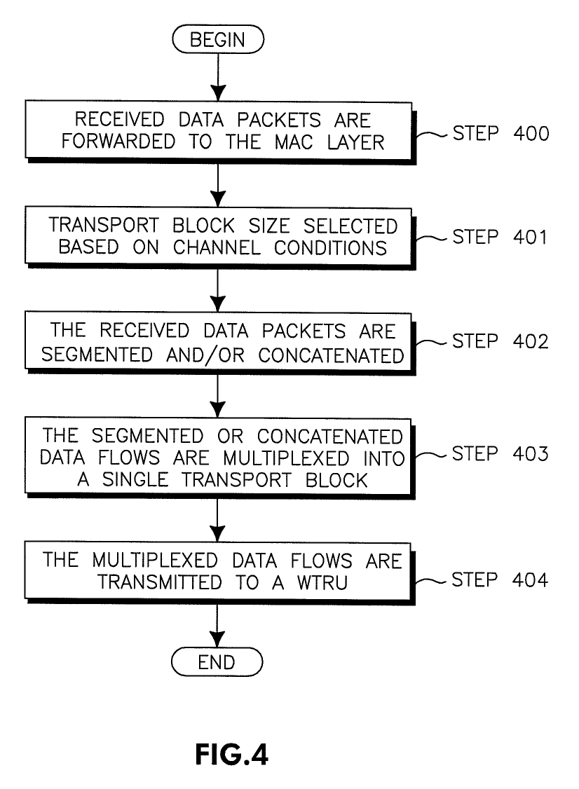

FIG. 4 shows a flow diagram of the disclosed method implemented in transmitter 120. RNC or higher layers 200 forwards to the MAC layer received data packets (step 400). MAC processor 240, located in the MAC layer, selects the TB size based on channel conditions using TFRC selector 210 (step 401). Segmentation and/or concatenation is performed by segm./conc. processors 220 on the received data packets based on the selected TB (step 402). The segmented or concatenated data flows are then multiplexed by multiplexor 212 into a single transport block (step 403). HARQ entity 211 then receives the multiplexed data flows from multiplexor 212 and transmits the multiplexed data flows to a WTRU (step 404).

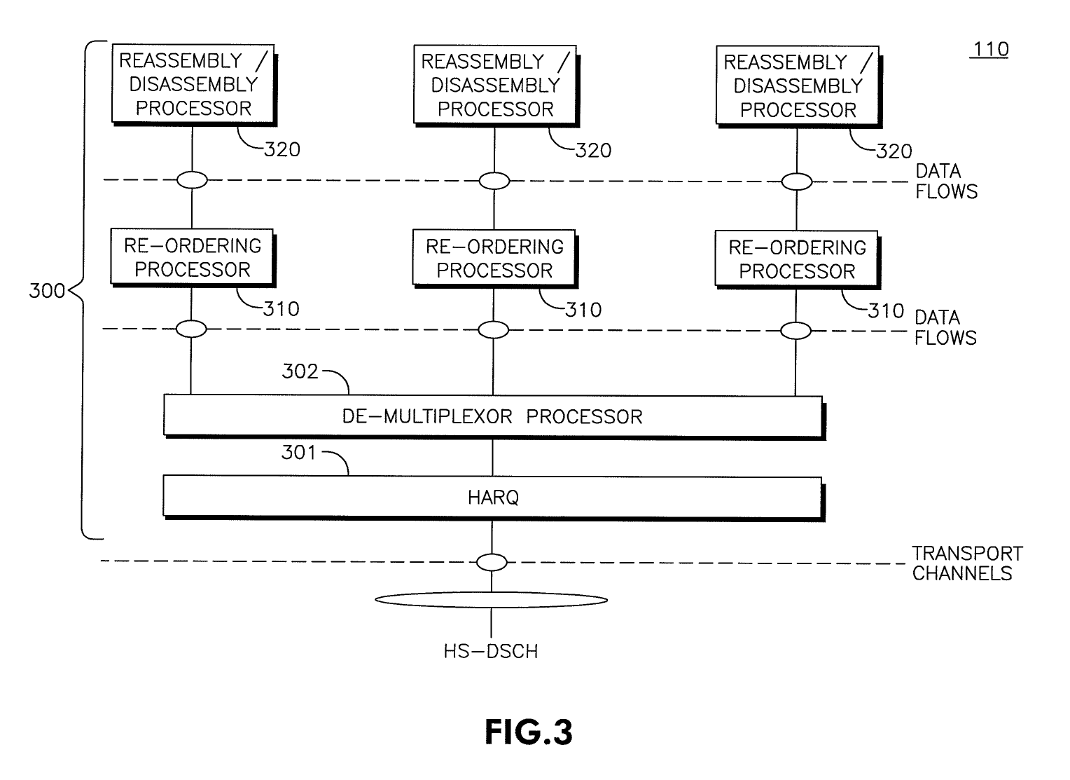

FIG. 3 shows a block diagram of receiver 110, preferably a WTRU, configured to implement the disclosed method. As shown in FIG. 1, receiver 110 comprises receiver 116 and processor 115. Referring back to FIG. 3, processor 115 comprises a MAC processor 300 for processing the multiplexed packets. MAC processor 300 comprises a HARQ entity 301, a de-multiplexor processor 302, a re-ordering processor 310, and reassemble/disassemble processor 320. Receiver 116 receives the multiplexed packets from transmitter 120 and forwards the multiplexed packets to MAC processor 300.

Once MAC processor 300 receives the multiplexed packets, the packets are forwarded to HARQ entity 301, which manages the HARQ processes, and de-multiplexor processor 302. De-multiplexor processor 302, coupled to HARQ entity 301 and reordering processor 310, receives the multiplexed packets and de-assembles the packets into segmented or concatenated data flow PDUs and distributes them to the appropriate data flow queues for reordering using the header information included in the received packets.

Reordering processors 310, coupled to de-multiplexor processor 302 and reassembly processor 320, receive the segmented or concatenated packets from de-multiplexor processor 302 and reorders them in preparation for transmission to higher layers. Alternatively, the re-ordering of packets can also be done in higher layers.

The reordered packets are then forwarded to reassembly processors 320, which reassembles the segmented packets or disassembles the concatenated packets and forwards the complete PDUs to the higher layers. It is preferable that MAC processor 300 includes a reordering processor 310 and a reassembly processor 320 per data flow.

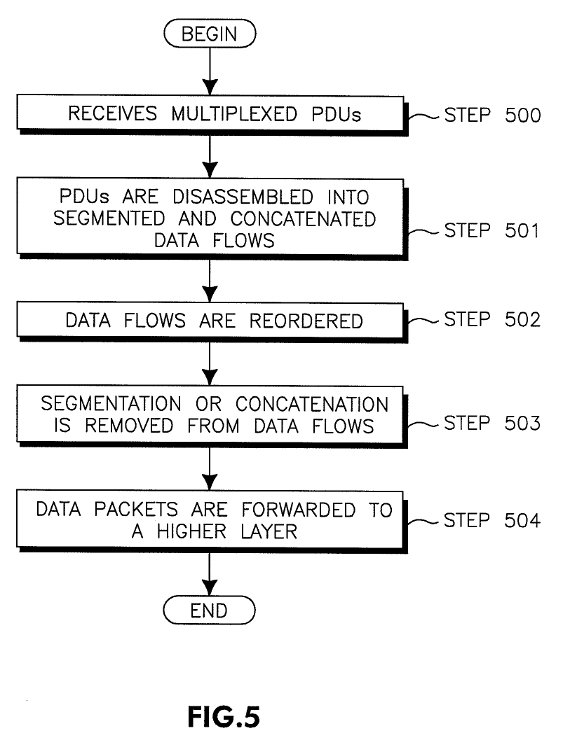

FIG. 5 shows an example flow diagram of the disclosed method used by receiver 110. Receiver 110, preferably a WTRU, receives the multiplexed packets (e.g., multiplexed PDUs) from a Node B at MAC processor 300 (step 500). The received multiplexed PDUs are disassembled into segmented and concatenated data flow PDUs by de-multiplexor processor 302 and distributed to the appropriate data flow queues (step 501). The de-assembled data flows are then forwarded to re-ordering processor 310, wherein the data flows are reordered (step 502). Reassembly processors 320 then receive the reordered data flows and reassemble the segmented data packets and/or disassemble the concatenated data packets (step 503). The data packets are then forwarded to the higher layers (step 504).

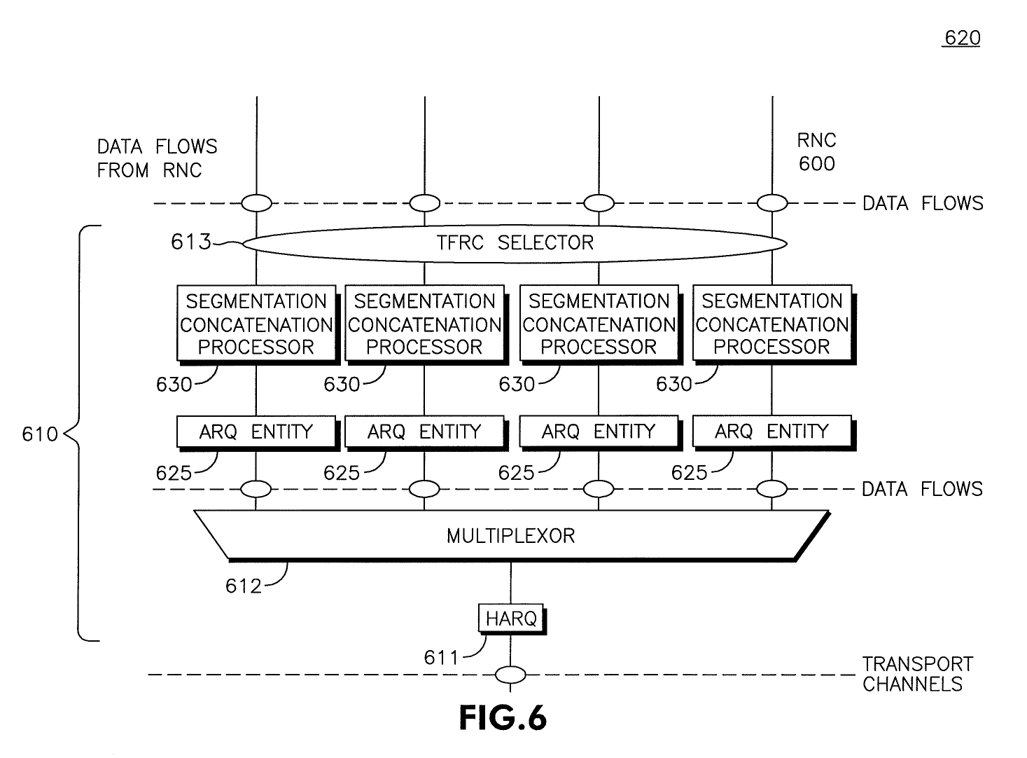

An alternate method is disclosed wherein multiple ARQ (fast retransmission) instances are included in the segm./conc. processor of the transmitter. FIG. 6 shows an example block diagram of this alternative method and apparatus. In accordance with this alternative, transmitter 620 comprises a MAC processor 610. MAC processor 610 comprises an HARQ entity 611, a multiplexor 612, one or more segm./conc. processor(s) 630, one or more with ARQ entities 625, and a TFRC selector 613. Receiver 620 receives a plurality of data packets from a WTRU and forwards the data packet to an RNC 600 or higher layers.

Similar to the transmitter illustrated in FIG. 2, TFRC selector 613 selects an appropriate TB size based on channel conditions using received data flows from RNC 600 or higher layers. The data flows are also forwarded from RNC 600 or higher layers to disclosed segm./conc. processor 630. Segmentation and/or concatenation is performed for each received data flows by segm./conc. processor 630. ARQ entity 625 then receives each segmented or concatenated data flows. In accordance with this alternative method, an error recovery or fast retransmission functionality through ARQ entities is included in the Node B per higher layer data-flow. Therefore, each data-flow will have an ARQ instance that will buffer and maintain the status information of all PDUs created in the process. Upon HARQ failures, the packets waiting to be acknowledged can be retransmitted.

A unique ARQ sequence number (SN) is generated by ARQ entity 625, for each PDU being created in the process. Retransmission, therefore, is based on the assigned ARQ SN. The ARQ SNs may be created per group of higher layer data-flow PDUs resulting in a multiple ARQ SN PDU, or a single ARQ SN PDU (but use RLC or a higher layer sequence number to reorder in the higher Layer).

Although the ARQ entity 625 has been disclosed as being implemented after segm./conc. processor 630, it should be noted that ARQ entity 625 may be implemented prior to segmentation or concatenation. Likewise, the multiplexing of data flows may be performed prior to the fast retransmission function for single ARQ instances or after the fast retransmission function for multiple ARQ instances.

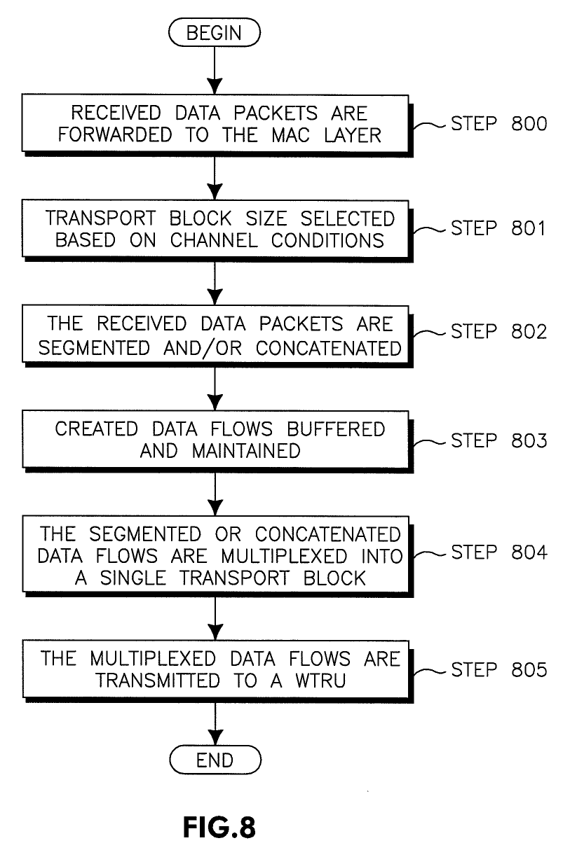

FIG. 8 shows a flow diagram of this disclosed alternative method used by a transmitter 620 configured to implement this alternative method, which includes the ARQ functionality. RNC or higher layers 600 forwards to the MAC layer received data packets from a WTRU (step 800). MAC processor 610, located in the MAC layer, selects the transport block (TB) size based on channel conditions using TFRC selector 613 (step 801). Segmentation and/or concatenation is performed by segm./conc. processors 630 on the received data packets based on the selected TB (step 802). ARQ entity 625 then buffers and maintains the status information of the created data flows (step 803). The segmented or concatenated data flows are then multiplexed by multiplexor 612 into one or more transport blocks (step 804). HARQ entity 611 then receives the multiplexed data flows from multiplexor 612 and transmits the multiplexed data flows to the WTRU (step 805).

As those having skill in the art should recognize, ARQ entities 625 are required only for Acknowledged Mode (AM) packets. However, Unacknowledged Mode (UM) and Transparent Mode (TM) packets are also processed by MAC processor 610. For UM and TM packets, no retransmissions are required, therefore MAC processor 610 must not perform fast retransmissions for these packets. ARQ entities 625 are therefore either transparent to these packets or by-passed. The higher layer data flows may correspond to one logical channel flow or to number of logical channels grouped together.

One alternative to dealing with UM/TM packets is to pre-configure the data flows to carry only one known logical channel and a header indicating the logical channel. A Node B, including transmitter 620, would then be able to distinguish between the logical channels that require ARQ and the ones that do not require ARQ. The data flows with no ARQ will only go through segmentation and/or concatenation as disclosed above. Therefore, the ARQ instance can be eliminated for that logical channel or transparent to the packets.

For data flows that correspond to a group of logical channels the packets may include a header that specifies if ARQ is required. Packets with no ARQ indication by-pass the fast retransmission function, and those one with an ARQ indication go through the ARQ functionality. Alternatively, the data flows can be separated into logical channels at the Node B. Therefore, the Node B distinguishes which logical channel requires ARQ. In another alternative, the data flows can be separated into flows with ARQ and flows with no ARQ.

When multiplexing is done prior to ARQ entity 625, multiplexing should be selective. Multiplexor 612, therefore, should be configured such that it allows only multiplexing of data flows from two groups, data flows with ARQ and data flows without ARQ. Therefore, the AM data flows can be multiplexed and then forwarded to ARQ entity 625, and the UM/TM data flows can be multiplexed together and forwarded directly to HARQ entity 611 (by-passing the ARQ).

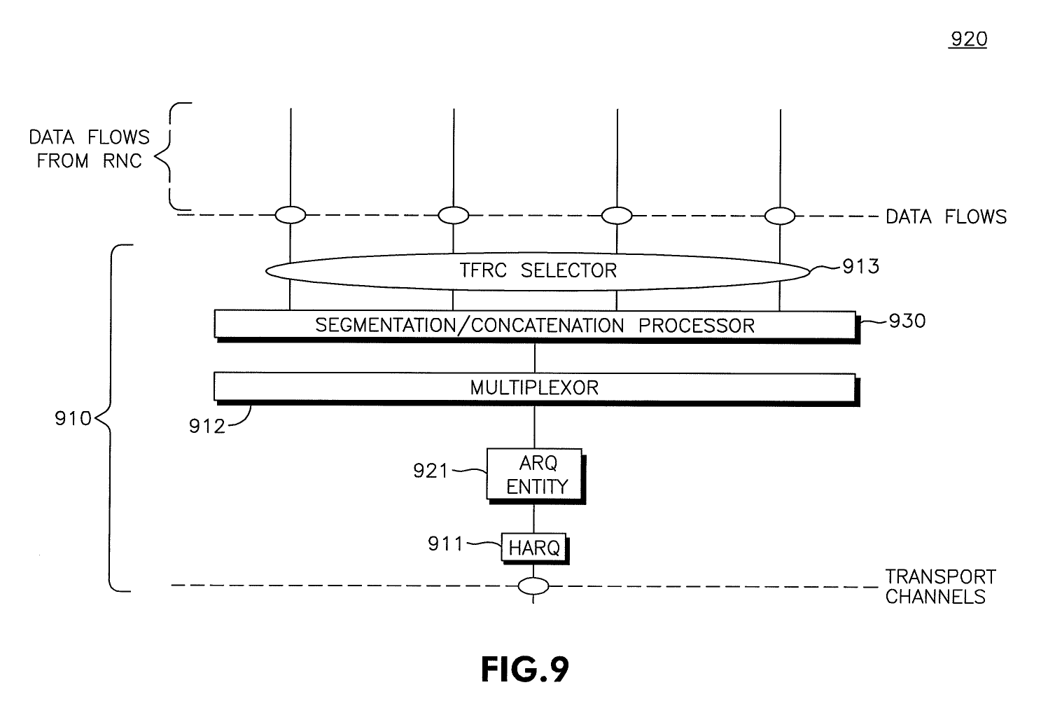

Alternatively, a single ARQ entity 921 is included in disclosed MAC processor 910 of this alternative. FIG. 9 shows a block diagram of a transmitter 920 configured to implement this alternative method. TFRC selection, conducted by TFRC selector 913, is done in the same way as described in the above alternative. Similarly, the segmentation and concatenation is performed by segm./conc. processor 930 as described above. In accordance with this alternative, a single ARQ entity 921, associated with the HARQ entity 911, is included in MAC processor 910. The multiplexing of the higher layer data-flows is performed by multiplexor 912 prior to ARQ entity 921 fast retransmission. This results in a single ARQ instance for many data flows. Multiplexor 912 multiplexes the data flows and the multiplexed packets are assigned an ARQ sequence number.

ARQ entity 921 is preferably used for error recovery purposes. The packets buffered in ARQ entity 921 preferably have a one to one correspondence with the packets in the HARQ entity. Upon HARQ failures ARQ entity 921 retransmits the failed packets. Upon successful transmission of a packet ARQ entity 921 may notify higher-layer/RLC ARQ entities in an RNC.

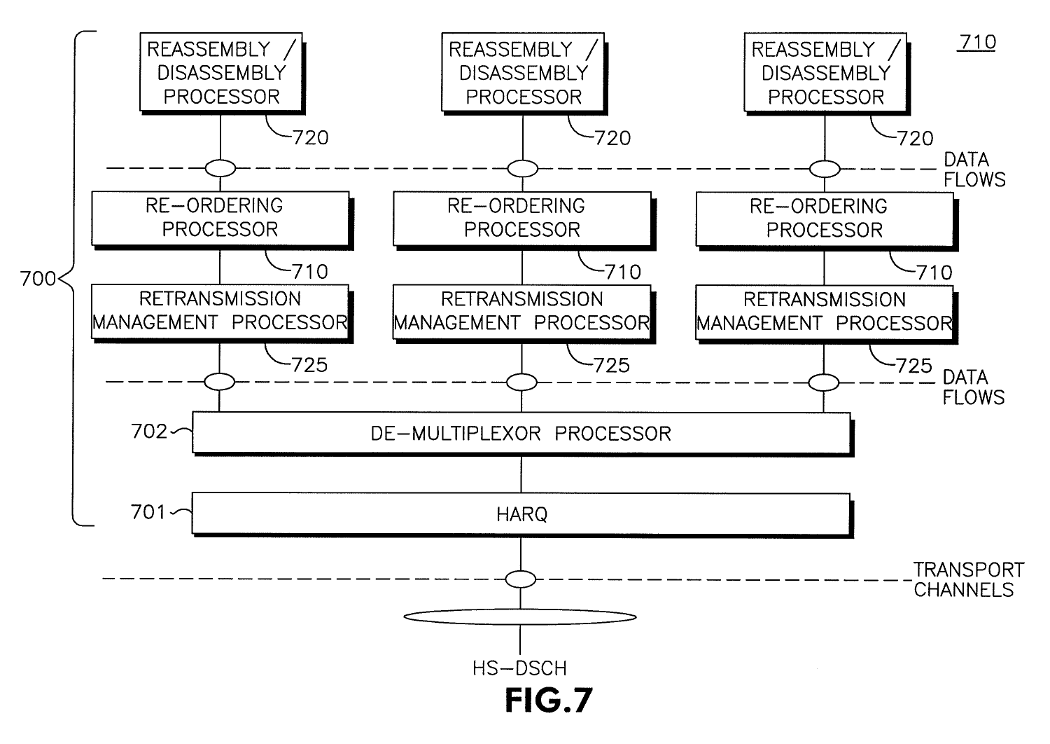

FIG. 7 shows an example receiver 710 configured to implement the disclosed alternative method, which includes a retransmission management processor 725 in MAC processor 700. Retransmission management processor 725, buffers packets upon receipt and generates a status report for a transmitter's peer ARQ entity. The status reports may be generated by retransmission management entity 725 when the transmitter (Node B) polls for status information.

The status information may include one or more of the following: simple ACK or NACK for each transmission; list of higher layer data-flows and lists of ARQ SNs; indication of ARQ SN for which the reception of packets received correctly; indication of ARQ SN of those packets not received correctly; a bit map corresponding to the ARQ SNs within the transmission window; ARQ entity ID; block ACK based reporting; and sent upon detection of a missing sequence number an the receiver's side.

The ARQ status information may be sent on the high speed dedicated physical control channel (HS-DPCCH) as follows: 1) extra (unused) bits on the HS-DPCCH to signal previous packet missing (if previous NACK to ACK misinterpretation occurs); or 2) if CQI is not sent on HS-DPCCH the corresponding bits can be used to signal ARQ SN. The ARQ status information may also be sent using the enhanced dedicated channel (E-DCH) or a new uplink channel.

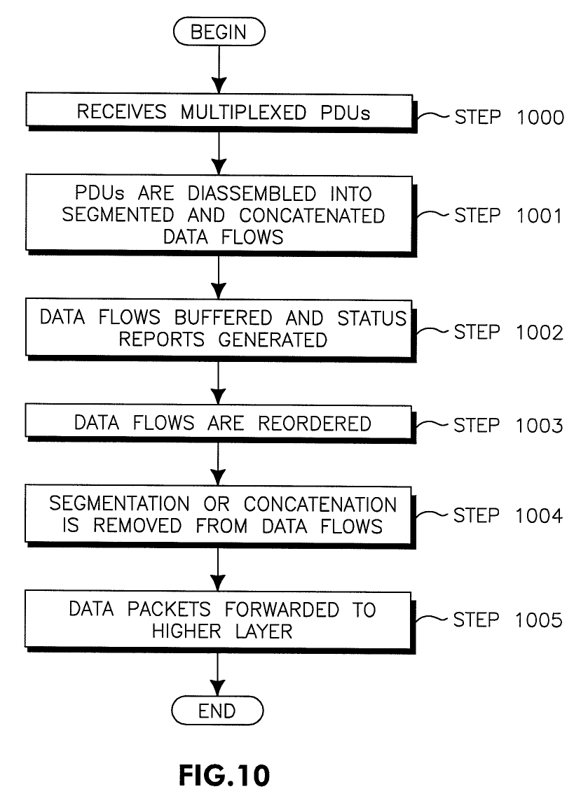

FIG. 10 shows an example flow diagram of the disclosed method used by receiver 710. Receiver 710, preferably located at a WTRU, receives the multiplexed packets from a Node B at MAC processor 700 (step 1000). The received multiplexed PDUs are disassembled into segmented and concatenated data flow PDUs by de-multiplexor processor 702 and distributed to the appropriate data flow queues (step 1001). The de-multiplexed data flows are then forwarded to retransmission management processor 725, where the data flows are buffered and status reports generated (step 1002), reordering processor 710 then receives the data flows and re-orders the data flows (step 1003). Reassembly processors 720 then receive the reordered data flows and reassemble the segmented data packets and/or disassemble the concatenated data packets (step 1004). The data packets are then forwarded to the higher layers (step 1005).

The hierarchy of the three window based ARQ loops is as follows: (1) upper ARQ of higher-layer/RLC, (2) Node B ARQ or lower ARQ, and (3) HARQ. Timers can be maintained at each of the three levels of the hierarchy. The timers may be coordinated between levels. When a lower level timer expires it may trigger or drive the upper layer to initiate a recovery procedure.

The ARQ functionality described herein can support a larger higher-layer/RLC PDU size from the RNC but can lead to mobility related issues in avoiding data loss or lower ARQ failure issues.

The Node B ARQ failure issue requires a robust and efficient error reporting. The Node B ARQ failure problem may be alleviated by the following mechanisms:

HARQ assisted ARQ can reduce the Lower ARQ failure and make it more robust.

Node B ARQ assisted higher-layer/RLC ARQ can decrease the overall latency.

On receiving lower ARQ status on uplink, the Node B supports a regeneration function that translates lower ARQ SN to upper ARQ SN:

Forward full information from Node B to RNC mapping ARQ PDUs to upper ARQ PDUs taking into account concatenation and segmentation cases.

Reduce higher-layer/RLC status to just polling or remove it since it may not be necessary with a tight Node B to RNC status reporting accounting for every packet.

Alternatively, when SN is reused, only relaying is applied.

To support retransmission on the downlink, signaling information may be sent on the HS-SCCH or a similar channel to indicate which HARQ transmission needs re-transmission based on QoS of the relevant higher layer data-flows. Retransmission based on ARQ SN is assigned to higher layer data-flow PDU groups based on higher layer data-flow priority or QoS—some higher layer data-flows need retransmission and others do not. Two methods for retransmission based on ARQ are proposed: (1) PDU based and (2) SDU based.

If the retransmission is PDU based, then the original SDU segmentation and PDU sequence numbering is preserved in the retransmission procedure. This would not adapt to changes in system conditions and corresponding TFC selection in the retransmission. However it is a simplistic retransmission scheme in spite of its inefficiencies.

If the retransmission is SDU based, then the ARQ SDU may be re-segmented with a new recommendation of ARQ PDU size from the MAC based on the new TFC selection. The SDU sequence numbering may be used here to create a sub-sequence number for the ARQ PDU. Another option is to specify the segment with the SDU sequence number and location information within the SDU (offset and length of segment from the beginning of the SDU). The second method has an advantage in allowing for re-segmenting if necessary and retransmitting only that part of the SDU that was indicated as not correctly received in the status feedback information. This also allows a more efficient reassembly of the ARQ SDU.

The number of retransmissions could be determined based on radio resources and scheduler. Alternatively, the number of retransmissions are based on data-flows multiplexed, based on a Timer, or based on a Specified Maximum Number.

Logic for radio link failure could be based on HARQ failure rate or Node B ARQ failure rate.

At the transmitter, ARQ SNs are used to buffer depending on ACK to NACK misinterpretation based on timer or on tracking octets. They are linked to Receiver Maximum number of retransmissions.

When moving from one cell to another two cases of handover can occur, intra-Node B and inter-Node B handover. In the case of intra-Node B handover, the Node B can support MAC/RLC preservation. Upon handover all the buffered SDUs or PDUs in the new ARQ sub-layer entity can be forwarded to the new cell within the Node B. The ARQ status information can be maintained and thus data loss can be minimized.

On the other hand, when inter-Node B handovers occur mechanisms to minimize data loss must be defined. The ARQ buffered packets in the source Node B can be lost. Recovery of data during a handover can become an important issue when large higher layer/RLC PDUs are allowed. One or a combination of the following options can be considered in order to avoid data loss:

Transfer the new ARQ sub-layer context from source Node B to target Node B. This would require forwarding of ARQ PDUs from source to target Node B. Data can be recovered from the source Node B at an SDU/PDU level.

Reset source Node B ARQ context and re-rout a buffered RLC PDUs/SDUs in the RNC waiting to be transmitted. Coordination between the Node B ARQ and RLC in the RNC must be performed. The Node B ARQ instances can inform the RLC in the RNC of the packets not successfully sent. Optionally the UE can send RLC status information to the RNC, indicating RLC PDUs/SDUs waiting to be received. This could introduce delays. If the source Node B resets the ARQ context the UE must also reset its retransmission management entities. Packets that can be reassembled successfully must be forwarded to higher layers and the ones waiting to be assembled deleted.

When Node B ARQ context is reset the AM packet can be recovered, however UM packets buffered in the Node B can be lost. An option is to add a buffer for UM packets in the RNC. The buffer can be time managed and/or limited by size. Packets buffered can be sent to the target Node B at the time of handover. This might result in duplicate transmissions over the air interface. To minimize this, some coordination between the source Node B and the RNC can be performed.

The data context stored in the Node B buffer may be forwarded to the target Node B at the time of handover. For UM data flows the source Node B may forward the data contained in the MAC buffer. More specifically, all data already delivered to the HARQ processes is not forwarded to the target Node B. This would alleviate the occurrence of duplicate transmissions in UM. Similar to UM, AM MAC data can also be forwarded from the source to the target Node B. The data in the HARQ processes is not delivered to avoid duplicate transmissions. Alternatively, the MAC forwards the data in the HARQ processes as well. Preferably, the data buffered in the Node B MAC queues is not assembled and thus no transmission sequence numbers have been assigned. The data is only assembled at the given TTI prior to being delivered to the HARQ process. This would allow the Node B to forward data without having to deliver the MAC specific information, such as TSN numbers. Alternatively, the source Node B also forwards the TSN numbers. The target Node B gives priority to the forwarded data from the source Node B.

Reestablish the higher-layer RLC context. This would result in data loss for both AM and UM.

Although the disclosed method has been described in the context of downlink operation, it is also applicable for UL operation by inverting the functions and procedures described in the WTRU and the Node B.

Although the features and elements are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for communicating comprising:
segmenting data packets of a plurality of data packets when said data packets are greater than a selected transport block size;
concatenating data packets of said plurality of data packets when said data packets are less than said selected transport block size; and
multiplexing said segmented or concatenated data packets into one or more transport blocks.

2. The method of claim 1 further comprising selecting said transport block size based on current channel conditions.

3. The method of claim 2 wherein said channel conditions include at least one of the following: Channel Quality Indicator reports, transmit power control, physical resources available, and scheduling restrictions.

4. The method of claim 2 wherein said segmentation and concatenation includes assigning sequencing numbers to the data packets created.

5. The method of claim 2 wherein said multiplexing is based on Quality of Service and available data.

6. The method of claim 5 wherein said multiplexing takes into account one or more of the following factors: transmission power, multiple input multiple output parameters and modulation and coding schemes.

7. The method of claim 2 wherein each multiplexed data flow is identified by a data flow ID.

8. The method of claim 7 wherein a Medium Access Control (MAC) header indicates the data flow ID of each multiplexed packet.

9. The method of claim 2 further comprising transmitting said multiplexed data packets.

10. The method of claim 1 further comprising buffering and maintaining status information of all data packets created.

11. The method of claim 10 further comprising retransmitting any data packets waiting to be acknowledged upon Hybrid Automatic Repeat Request (HARQ) failures.

12. The method of claim 10 wherein a unique Automatic Repeat Request (ARQ) sequence number is generated for each data packet created.

13. A Node B comprising:
one or more segmentation/concatenation processors for segmenting data packets of a plurality of data packets when said data packets are greater than a selected transport block size, and concatenating data packets of a plurality of data packets when said data packets are less than said selected transport block size; and
a multiplexor for multiplexing said segmented or concatenated data packets into one or more transport blocks.

14. The Node B of claim 13 further comprising a Transport Format Resource Combination (TFRC) processor for selecting said transport block size based on current channel conditions.

15. The Node B of claim 14 wherein said channel conditions include at least one of the following: Channel Quality Indicator reports, transmit power control, physical resources available, and scheduling restrictions.

16. The Node B of claim 14, wherein said multiplexing is based on Quality of Service and available data.

17. The Node B of claim 16, wherein said multiplexing takes into account one or more of the following factors: transmission power, multiple input multiple output parameters and modulation and coding schemes.

18. The Node B of claim 14 wherein each multiplexed data flow is identified by a data flow ID.

19. The Node B of claim 18 wherein a Medium Access Control (MAC) header indicates the data flow ID of each multiplexed packet.

20. The Node B of claim 14 further comprising a Hybrid Automatic Repeat Request (HARQ) for managing the transmission of said multiplexed data packets.

21. The Node B of claim 13, wherein each of said one or more segmentation/concatenation processors is associated with each of said plurality of data packets.

22. The Node B of claim 14 further comprising an Automatic Repeat Request (ARQ) Entity for buffering and maintaining said received data packets for error recovery or fast retransmission.

23. The Node B of claim 22, wherein said ARQ entity assigns a unique ARQ sequence number for each segmented or concatenated data packet.

24. A method of communicating comprising:
disassembling a received multiplexed data packet into a plurality of segmented and concatenated data packets;
reordering said segmented and concatenated data packets; and
reassembling said segmented data packets and disassembling said concatenated data packets.

25. The method of claim 24, wherein each of said segmented and concatenated data packets includes an Automatic Repeat Request (ARQ) sequence number.

26. The method of claim 25 further comprising buffering and generating a status report for each of said segmented and concatenated data packets.

27. The method of claim 26, wherein said status reports are generated using said ARQ sequence number.

28. A wireless transmit receive unit (WTRU) comprising:
a disassembly processor for disassembling a received multiplexed data packet into a plurality of segmented and concatenated data packets;
a reordering processor for re-ordering said segmented and concatenated data packets; and
a reassembly/disassembly processor for reassembling said segmented data packets and disassembling said concatenated data packets.

29. The WTRU of claim 28, wherein each of said segmented and concatenated data packets includes an Automatic Repeat Request (ARQ) sequence number.

30. The WTRU of claim 29 further comprising a retransmission processor for buffering and generating a status report for each of said segmented and concatenated data packets.

31. The WTRU of claim 30, wherein said status reports are generated using said ARQ sequence number.
